(19) United States
(12) Patent Application Publication
(10) Pub. No.: US 2010/0055221 A1
(43) Pub. Date: Mar. 4, 2010

(54) Assembly and Method for Magnetic Embossing Roll Surfacing

(75) Inventor: Ricky Hein, Newton, KS (US)

Correspondence Address: KENNETH H. JACK, 2121 MAPLE, WICHITA, KS, 67213, US

(73) Assignee: BUNTING MAGNETICS CO., Newton, KS (US)

(21) Appl. No.: 12/204,233

(22) Filed: Sep. 4, 2008

(51) Int. Cl. B29C 59/04; B05D 3/12; B44B 5/02; C23C 4/08

(52) U.S. Cl. 425/3; 427/367; 427/580; 427/455; 425/471; 425/194; 264/284

(57) ABSTRACT

A magnetic roll for embossing, the magnetic roll incorporating a cylindrical core having a base radial dimension, the base radial dimension being less than a finished radial dimension; magnet receiving channels within the cylindrical core; a multiplicity of magnets attached within the magnet receiving channels; at least a first armature effect resisting metal band, the band adhering to the cylindrical core's first circumferential surface, the band overlying a plurality of the magnets, and the band consisting of a deposition of metal sprayed molten metal droplets; and an outer surface, the outer surface being a radially outer periphery of the at least first armature effect resisting metal band, the outer surface being ground to reside at a finished radial dimension.

### FIELD OF THE INVENTION

This invention relates to methods, apparatus, and assemblies for roller press actuated sheet material embossing. More particularly, this invention relates to specially configured magnet embedded rolls which are adapted for holding flexible magnetic embossing dies.

### BACKGROUND OF THE INVENTION

Magnet embedded rolls or rollers are commonly utilized for supporting flexible ferromagnetic or paramagnetic embossing plates. In such usage, a thin and flexible ferromagnetic embossing plate is wrapped circumferentially about the roll, allowing the roll's typically exposed and embedded magnets to securely magnetically hold the plate as a radial extension of the roll. However, such magnetic roll and ferromagnetic plate assembly often undesirably produces a “ghosting” effect (discussed below) upon the sheet material which is embossed by the assembly.

Where a magnetic roll and ferromagnetic embossing plate assembly, such as is described above, is utilized for heated embossing of very thin holographic film, an undesirably embossed pattern matching the pattern of the roll's magnets and channels may be impressed into the holographic film along with the intended embossed patterns and images. Such undesirable additionally embossed magnet pattern is commonly referred to as “ghosting”, such embossing irregularities typically ruining the intended holographic film work product.

The “ghosting” effects described above are understood to be attributable to difficulties associated with precision grinding of the typical outer or finished circumferential surface of a magnetic roll. Upon attempting to grind a magnetic roll to a precise consistent radial dimension, the grinding wheel variably contacts the roll's substrate or core material (which commonly comprises mild steel) and the exposed radially outer surfaces of the embedded magnets. Such two materials elastically respond differently at the locus of grinding, resulting in microscopic differences between the two ground surfaces. Such differences in the material characters of the surfaces to be ground are understood to contribute to or cause small localized variations in the roll's radius of curvature and radial dimension. Additionally, in heated embossing processes such as those typically performed in holographic film embossing, differences between the thermal characteristic of a magnetic roll's substrate material and that of the embedded magnets commonly result in thermal variations along the surface of the roll. Such thermal variations are understood to additionally contribute to or cause an undesirable “ghost” pattern upon the embossed work product.

The instant inventive assembly and method for magnetic embossing roll surfacing solves or ameliorates the problems discussed above by spraying a stream of high velocity molten metal droplets over the outer circumferential roll surface to create a metal deposition or a build-up layer, and by subsequently precision grinding such metal sprayed outer layer to a consistent radial dimension.

### BRIEF SUMMARY OF THE INVENTION

The base or supporting structural component of the instant inventive magnetic roll for sheet material embossing comprises a cylindrical core having an axial length and having a first or base circumferential surface. The cylindrical core's circumferential surface necessarily has a base radial dimension measured from a central axially extending axis of rotation within the cylindrical core. The cylindrical core functions as a substrate or base which supports overlying structures such as embedded magnets, embedded magnetic pole pieces, metal sprayed circumferential surface covering layers, and a magnetically attached embossing, as will be further discussed below.

In a preferred embodiment of the instant invention, the cylindrical core substrate comprises mild steel, such material being durable and being economically obtained. Other cylindrical core substrate materials such as brass, stainless steel or aluminum may be suitably substituted. Where the roll is to be utilized in a heated application such as is typically performed in holographic film embossing, the cylindrical core substrate is preferably specially adapted for heating via heated oil pumped through internal channels provided within the cylindrical core, or via internally mounted electrical resistance “cal rod” heaters.

Magnet receiving channels are preferably milled radially inwardly from the circumferential outer surface of the cylindrical core. Thereafter, magnets are preferably fixedly mounted within such channels. Preferably, the magnets are durably held within the channels through the use of an epoxy adhesive, and the magnets are specially arranged in a “NN, SS, NN, SS . . . ” magnetic pole configuration along the channels, such pole configuration enhancing lines of magnetic flux emanating from the surface of the roll and enhancing the plate fixing strength of the roll. For additional plate fixing magnetic strength, mild steel pole pieces are preferably adhesively mounted between each of the magnets. In many applications, high strength ceramic magnets may be mounted upon the roll. However, where the roll is intended for use in heated applications, temperature tolerant magnets such as a samarium cobalt magnets are preferably used. Upon installation of the magnets within such channels, the assembled cylindrical core, magnets, and pole pieces combination is preferably ground to a consistent base radial dimension, such dimension preferably being between 0.007″ and 0.008″ less than a desired finished radial dimension of the roll.

In a preferred embodiment of the instant invention, at least a first armature effect resisting metal band is preferably adhered to the cylindrical core's first or base circumferential surface, such band comprising a deposition or build-up of sprayed molten metal droplets. Such deposition is preferably accomplished via utilization of a commonly known metal arc spraying, metal flame spraying, plasma metal spraying, or HVOF (high velocity oxy-fuel) metal spraying process. In order to prevent the sprayed deposition metal band from magnetically armaturing across the roll's north and south magnetic poles, the metal chosen for use in the metal spraying application preferably is non-paramagnetic or non-ferromagnetic in character, such metal preferably comprising stainless steel, a stainless steel alloy, aluminum, an aluminum alloy, copper, a copper alloy, zinc, a zinc alloy, tin, or a tin alloy. In a preferred embodiment of the instant invention, metal which is sprayed in molten droplet form over the cylindrical core and over the magnets comprises stainless steel. In order to enhance the initial adhesion of the metal sprayed layer at the exposed outer surfaces of the embedded magnets, a thin bond coating comprising an alloy such as an aluminum and nickel alloy may be metal sprayed prior to the application of a thicker stainless steel metal spray coating.

In a preferred performance of the method, the cylindrical core is rotated swiftly at approximately 84 RPM contemporaneously with application of the metal sprayed coatings. Such rotation during metal spraying desirably helically extends an adhered metal band consisting of a deposition or build-up of initially molten metal droplets over the circumferential surface of the cylindrical core. Such metal band is preferably further extended in a partially overlapping configuration in several axial spraying passes until such metal deposition band makes up an axially and circumferentially continuous outer surface layer. Such outer surface layer preferably comprises a temporary outer circumferential surface having a temporary radial dimension, such temporary outer surface preferably having a radial dimension between 0.01″ and 0.02″ greater than the intended finished radial dimension of the roll.

Upon complete application of the metal sprayed layer, the roll is preferably precision ground to a consistent radial dimension matching the intended finished radial dimension of the magnetic roll.

When the finished roll is utilized, for example, for supporting a holographic film embossing die for embossing holographic film, no “ghost” pattern is embossed upon the holographic film work product.

Accordingly, objects of the instant invention include the provision of and assembly of components, and the performance of method steps such as are described above. Other and further objects will become known to those skilled in the art upon review of the Detailed Description which follows, and upon review of the appended drawings.

### BRIEF DESCRIPTION OF THE DRAWINGS

FIG. 1 is a perspective view of the instant inventive sheet material embossing magnetic roll.

FIG. 2 redepicts FIG. 1, the view of FIG. 2 showing a removal of a metal sprayed outer layer, the view additionally showing a removal of encapsulated embedded magnets.

FIG. 3 redepicts FIG. 2, the view of FIG. 3 additionally showing embedded magnets, and additionally showing a progression of helically extending metal sprayed metal band.

FIG. 4 is a sectional view as indicated in FIG. 3, the view of FIG. 4 additionally representationally showing the metal spraying method step.

FIG. 5 is a partial sectional view as indicated in FIG. 3, the view of FIG. 5 including exemplary magnetic flux lines.

FIG. 5A redepicts FIG. 5, the view of FIG. 5 demonstrating magnetic flux line diminishment upon a metal sprayed coating materials change.

### DETAILED DESCRIPTION OF A PREFERRED EMBODIMENT

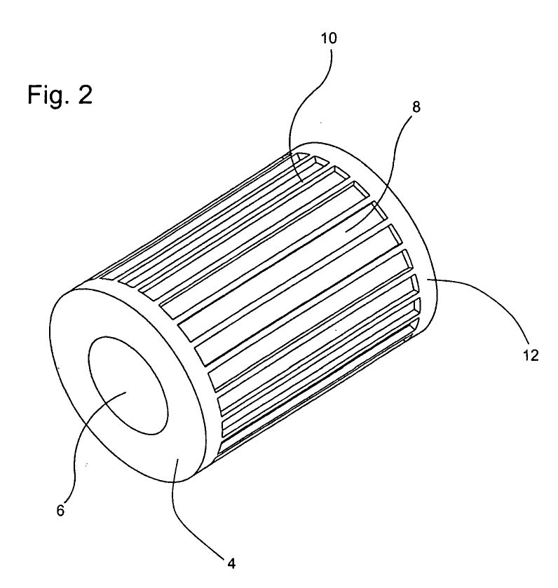

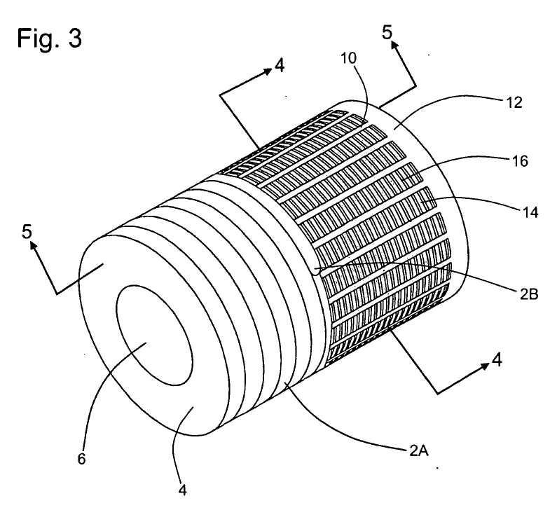

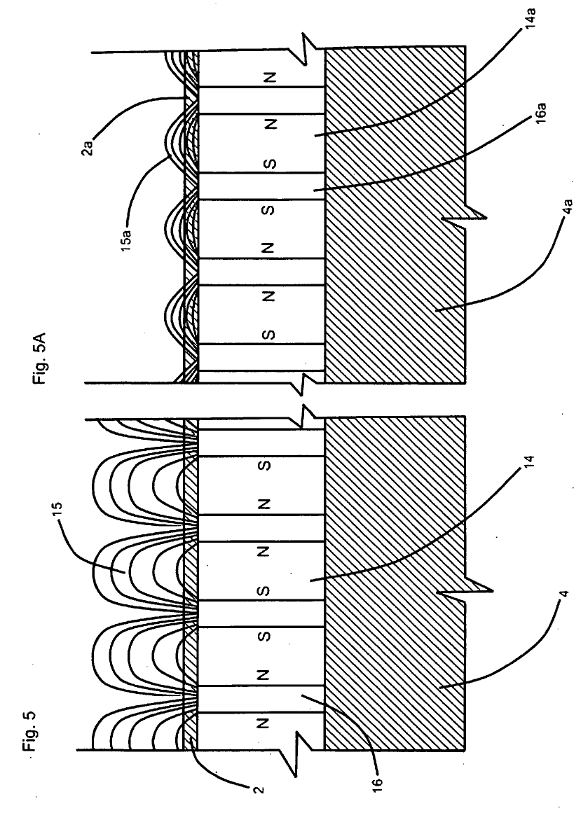

Referring now to the drawings, and in particular to FIG. 2, a cylindrical core or substrate 4 has an axially extending hollow bore 6. The cylindrical core 4 has a first or base circumferential outer surface 12, such surface preferably having a plurality of magnet receiving channels 8 milled therein. The milling of the magnet receiving channels 8 advantageously forms magnet retaining ridges or partitions 10. Referring further simultaneously to FIG. 3, a multiplicity of magnets 14 and mild steel magnetic pole pieces 16 are preferably fixedly mounted through utilization of an epoxy adhesive within the channels 8. Referring further simultaneously to FIG. 5, the magnets 14 are preferably fixed within the channels 8 in polar orientations wherein the magnets' abutting north poles and south poles face each other. Such “NN, SS, NN, SS . . . ” pole orientation advantageously directs magnetic lines of flux 15 radially outwardly from the roll at a multiplicity of points along the roll's circumferential surface rather than undesirably allowing such flux lines to extend axially in series between the magnets.

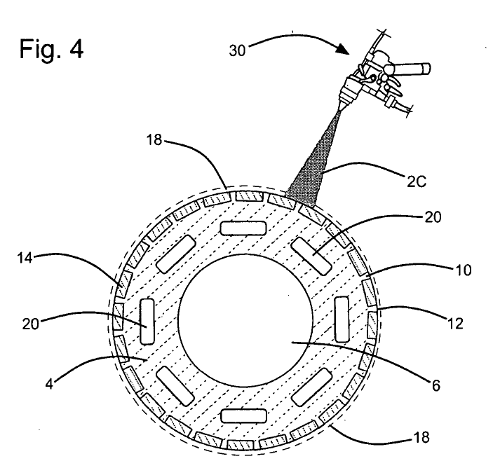

Referring to FIG. 4, where the cylindrical core 4 is to be utilized in a heated application, such as heated holographic film embossing, axially extending channels 20 within the core 4 are preferably provided, such channels 20 allowing heated oil to be pumped and coursed therethrough for heating of the cylindrical core. Such channels 20 are additionally representative of electric resistance heater “cal rod” receptacles. Also in such heated application, the magnets 14 preferably comprise temperature tolerant samarium cobalt magnets.

Referring to further FIG. 4, the spray gun image which is identified by Reference Arrow 30 is representative of the performance of a metal spraying process upon the circumferential surface 12 of the cylindrical core 4. Preferably, the metal spraying process comprises an electric arc spraying, flame spraying, plasma spraying, or HVOF (high velocity oxy-fuel) spraying process, each of which is known to and is readily performable by those skilled in the art. Performance of such a metal spray process propels molten or semi-liquid metal droplets 2C at high velocity to impinge against the outer circumferential surface 12 of the cylindrical core 4. Such droplets 2C quickly cool upon high velocity impact to form an adhering deposition or build-up layer of metal. In a preferred embodiment of or performance of the instant invention, the preferred metal choice for the creation of such metal sprayed deposition comprises stainless steel. Where stainless steel is utilized, a bonding or undercoat layer of an aluminum and nickel alloy may be advantageously initially sprayed, such bonding layer enhancing metal adhesion at the exposed surfaces of the magnets 14. As will be discussed below, it is important that the sprayed metal and the resultant metal deposition layer comprise a non-paramagnetic metal or metal alloy such as non-magnetic stainless steel, a non-magnetic stainless steel alloy, aluminum, an aluminum alloy, copper, a copper alloy, zinc, a zinc alloy, tin, or a tin alloy.

Referring simultaneously to FIGS. 5 and 5A, where the metal sprayed cylinder coating layer 2 comprises a non-paramagnetic metal material, magnetic lines of flux 15 advantageously transparently pass therethrough. In contrast, referring to FIG. 5A, the metal sprayed coating layer 2a may undesirably comprise a paramagnetic metal such as mild steel. Such a paramagnetic metal sprayed layer 2a undesirably produces an armaturing effect between the north and south poles of the magnets 16A, allowing lines of magnetic flux 15a emanating from and entering the magnetic pole pieces 16a to pass primarily through the metal sprayed layer 2a, and to extend between successive pole piece 16a without significantly emerging from the outer circumferential surface of the layer 2a. Such armaturing effect undesirably reduces magnetic strength at the surface of the roll. Accordingly, armaturing effect resistant metals or non-paramagnetic metals such as non-magnetic stainless steel are preferably utilized in the metal spraying step.

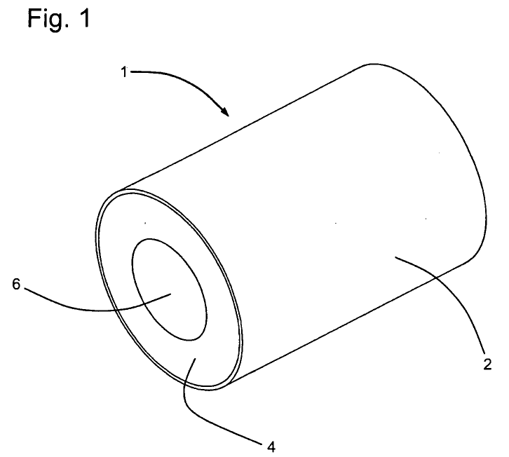

Referring simultaneously to FIGS. 3 and 4, while the metal spray jet 2C is directed against the outer surface 12 of the cylindrical core 4, such core is preferably rotated at approximately 84 RPM. Such rotation during the metal spraying application advantageously produces a helically extending metal spray band 2A, such band having a helically progressing end 2B. Such helical band creating metal spraying step preferably continues along the axial length of the cylindrical core 2 until, referring further to FIG. 1, an axially and circumferentially continuous metal sprayed layer 2 is deposited or built up over the cylindrical core 4, such layer 2 completely encapsulating the magnets 14 and the magnetic pole pieces 16.

Referring simultaneously to FIGS. 1 and 3, upon such complete magnet encapsulation, the roll 1 may be turned and ground to create a precision second or outer circumferential surface of the metal sprayed layer 2, such grinding resulting in the creation of a finished magnetic roll 1.

In a preferred embodiment of the instant invention, the cylindrical core 4, along with its exposed magnets 14 and magnetic pole pieces 16 are initially ground to a radial dimension that is between 0.007″ and 0.008″ less than the intended finished radial dimension of the roll. Upon the metal spraying application of the metal deposition band 2A, such radial dimension is preferably temporarily increased to 0.01″ to 0.02″ greater than the roll's intended finished radial dimension. Thereafter, the roll 1 may be re-ground to the intended finished radial dimension. At such dimension, the metal sprayed layer 2 preferably has a radial thickness between 0.007″ and 0.008″, the thickness of the layer 2 indicated in FIG. 1 being exaggerated for the purpose of view.

Referring to FIGS. 1 and 4, the circumferential dashed line 18 is representative of a pair of circumferentially and radially extending ridges positioned at opposite axial ends of the metal deposition layer 2. Such circumferential ridges 18 may be advantageously extended from the cylindrical core 4 to protect and shield from damage the otherwise exposed axial ends of the metal deposition layer 2.

In practice and use of the instant invention, referring simultaneously to FIGS. 1 and 3, the metal sprayed deposition layer 2 may be ground to a radial dimension which is more precise and consistent than that achievable by otherwise grinding the underlying substrate 4, magnets 14, and pole pieces 16. Also, such layer 2 advantageously dispels surface temperature variations, making the temperature along the roll's surface homogeneous. Accordingly, upon wrapping of a flexible magnetic holographic film embossing plateabout the roll 1, and upon utilizing such assembled roll for holographic film embossing, a high quality work product may be produced without the impression of any undesirable “ghost” images upon the work product.

While the principles of the invention have been made clear in the above illustrative embodiment, those skilled in the art may make modifications in the structure, arrangement, portions, components, and method steps of the invention without departing from those principles. Accordingly, it is intended that the description and drawings be interpreted as illustrative and not in the limiting sense, and that the invention be given a scope commensurate with the appended claims.

1. A magnetic roll useable for sheet material embossing, the magnetic roll having a finished radial dimension, the magnetic roll comprising:
(a) a cylindrical core, the cylindrical core having an axial length and having a first circumferential surface, the first circumferential surface being positioned at a base radial dimension, the base radial dimension being less than the finished radial dimension;
(b) a plurality of magnet receiving channels, each magnet receiving channel extending radially inwardly into the cylindrical core from the first circumferential surface;
(c) a multiplicity of permanent magnets, each magnet being fixedly attached to the cylindrical core and having an outer periphery, each fixed attachment positioning one of the magnets within one of the magnet receiving channels;
(d) a metal layer adhering to the cylindrical core's first circumferential surface and adhering to the permanent magnets' outer peripheries, said layer comprising a deposition of sprayed metal droplets; and
(e) a second circumferential surface, the second circumferential surface comprising a radially outer periphery of the metal layer, the second circumferential surface being positioned at the finished radial dimension.

2. The magnetic roll of claim 1 wherein the metal layer comprises a sprayed deposition of metal selected from the group consisting of stainless steel, stainless steel alloys, aluminum, aluminum alloys, copper, copper alloys, zinc, zinc alloys, tin, and tin alloys.

3. The magnetic roll of claim 1 wherein the metal layer comprises at least a first armature effect resisting band, said band being arranged to extend helically about the cylindrical core.

4. The magnetic roll of claim 3 wherein the second circumferential surface is circumferentially and axially continuous.

5. The magnetic roll of claim 4 wherein the second circumferential surface comprises a ground surface having a consistent radius of curvature.

6. The magnetic roll of claim 4 wherein the second circumferential surface has a pair of axial ends, and further comprising a pair of circumferential ridges extending radially outwardly from the cylindrical core, each circumferential ridge being positioned to shield one of the second circumferential surface's axial ends.

7. A method for surfacing an embossing magnetic roll, the method comprising steps of:
(a) applying a metal sprayed outer circumferential surface to the magnetic roll; and
(b) grinding the metal sprayed outer circumferential surface to a consistent finished radial dimension.

8. The magnetic roll surfacing method of claim 7 wherein the applying step comprises spraying an armature effect resisting metal.

9. The magnetic roll surfacing method of claim 8 wherein the applying step further comprises selection of the armature effect resisting metal from the group consisting of stainless steel, stainless steel alloys, aluminum, aluminum alloys, copper, copper alloys, zinc, zinc alloys, tin, and tin alloys.

10. The magnetic roll surfacing method of claim 9 wherein the applying step further comprises simultaneously rotating the magnetic roll.

11. The magnetic roll surfacing method of claim 10 wherein the applying step helically extends an armature effect resisting metal band about the magnetic roll.

12. The magnetic roll surfacing method of claim 10 wherein the applying step further comprises performance of a metal spraying technique selected from the group consisting of electric arc spraying of molten metal material, flame spraying of molten metal material, plasma spraying of molten metal material, and high velocity oxy-fuel spraying of molten metal material.
